(19) United States
(12) Patent Application Publication
(10) Pub. No.: US 2025/0145470 A1
(43) Pub. Date: May 8, 2025

(54) SYNTHESIS AND APPLICATION OF LIGNIN-BASED CARBON MATERIALS

(71) Applicant: UNIVERSITY OF TENNESSEE RESEARCH FOUNDATION, Knoxville, TN (US)

(72) Inventors: Lu YU, Knoxville, TN (US); David Paul Harper, Knoxville, TN (US); David Keffer, Knoxville, TN (US)

(73) Assignee: UNIVERSITY OF TENNESSEE RESEARCH FOUNDATION, Knoxville, TN (US)

(21) Appl. No.: 18/947,757

(22) Filed: Nov. 14, 2024

Related U.S. Application Data
(63) Continuation-in-part of application No. PCT/US2023/019952, filed on Apr. 26, 2023.
(60) Provisional application No. 63/365,379, filed on May 26, 2022.

(51) Int. Cl. C01B 32/318; B01D 15/16; B82Y 20/00; C01B 32/15; C01B 32/348

(52) U.S. Cl. CPC C01B 32/318; B01D 15/165; C01B 32/15; C01B 32/348; B82Y 20/00; C01P 2002/82; C01P 2002/85; C01P 2002/86; C01P 2004/03; C01P 2006/12; C01P 2006/60

(57) ABSTRACT

This application relates to the development and use of lignin-based carbon materials which can be used for energy storage and environmental applications. Included are methods of preparing microporous activated carbon having a controlled, often high surface area and a controlled often high mesopore ratio, and a method of preparing carbon dots, for example carbon quantum dots.

### RELATED APPLICATIONS

This application is a continuation-in-part of International Application PCT/US2023/019952, filed on Apr. 26, 2023, which in turn claims the benefit of U.S. Provisional Application No. 63/365,379, filed May 26, 2022, the disclosures of which are incorporated herein by reference.

### STATEMENT REGARDING FEDERALLY SPONSORED RESEARCH

This invention was made with government support under grant number BETO EE0008353, awarded by the United States Department of Energy. The government has certain rights in the invention.

### TECHNICAL FIELD

This application relates to the development and use of lignin-based carbon materials which can be used for energy storage and environmental applications.

### BACKGROUND

Lignin is a class of polyaromatic compounds that includes about 25% of lignocellulosic biomass plant cell wall. It is the second most abundant natural polymer in the world and millions of tons are produced annually as a coproduct of pulp and paper production. Lignin is a highly branched heterogeneous polymer built up with phenylpropane units and has a high carbon content (>60 wt. %), which makes it an excellent fuel for pulp production. However, much of the lignin co-product of the pulping process is regarded as a waste product with relatively low value. Due to its complex and irregular structure and contamination from sugars and processing chemicals, lignin is difficult to isolate and convert into high-value commercial uses. Approximately 98% of the available lignin is burned for power generation, which has some monetary value, and the remaining (<2%) is used for developing specialty products.

Numerous attempts have been made to valorize lignin. Attempts to apply the aromatic structure to high value products, including carbonaceous materials, surfactants, foams, and adhesives, have resulted in little market penetration.

Lignin is a random combination of three basic monomer types: p-coumaryl alcohol (H), coniferyl alcohol (G), and sinapyl alcohol (S) as shown below.

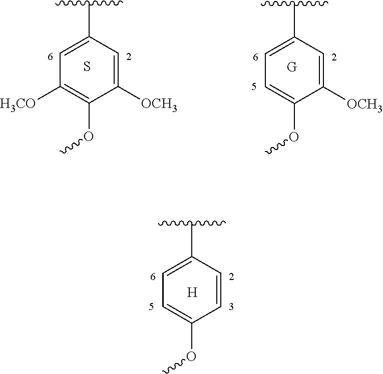

The aliphatic side chain is usually attached at C-1 with the carbons on side chain. The phenol oxygen is usually located at C-4 and sometimes there is a methoxy group located at C-3. The carbon groups at C-5 are usually referred to as “condensed” structures in both native lignin in plant cell wall prior to pulping, and C-5 linkages formed during lignin extraction. All these constituents together form a three-dimensional network structure composed of phenylpropane units connected with ether and C—C bonds. The composition of lignin highly depends on its raw material sources and isolation process. These can be classified into three broad classes, softwood, hardwood, and herbaceous (grass) lignin, based on their composition in structural units. Softwood has higher lignin content (˜28%) compared with hardwood (˜20%) and grass (˜15%). The principle monomer for softwood lignin is G, whereas lignin from hardwood usually has more S and G monomers, and the H monomer is more prominent in lignin from grasses.

The most prevalent commercially used chemical pulping process is the kraft process, which uses sodium hydroxide as the main reagent combined with sodium sulfide as a nucleophile catalyst for lignin degradation and separation from cellulose. The kraft process has many advantages including low energy requirements, favorable economics, excellent chemical recyclability, and coproduct generation. The kraft process can pulp virtually any lignocellulosic feedstocks, resulting in high pulp strength but low pulp yields (˜45-55%) compared to some other methods.

Lignin may also be isolated from biomass using a biomass-derived renewable γ-valerolactone (GVL) solvent. The key feature of this process is the high-efficiency, high-yield fractionation of biomass into different components, and ability to pulp a wide range of biomass feedstocks. Lignin derived by the GVL method has high purity with minimal ash and sugar content, which makes it an excellent candidate for high-quality carbon materials.

Activated carbons (ACs) are high-porosity materials which are assemblies of defective graphene layers that come from organic parent materials after carbonization and physical/chemical activation process. A solid-phase carbonization proceeds in the solid state with the removal of atoms and replacement within a solid lattice, without bulk materials movement. Accordingly, the structure of parent materials is closely related to the structure of the carbonized char. Usually the carbonization is carried out in an inert atmosphere at an elevated temperature. The structure of the produced char is a combination of nano-graphene sheets with different sizes and directions, including heteroatoms, linear carbons, holes, and dangling bonds in virtually infinite physicochemical possibilities. The random bonding together of these short-range non-planar units creates imperfect packing (space), called porosity. Disorder of the parent substances is central to producing porosity, upon which the properties of activated carbons rely. Different parent materials decompose in their own ways and lead to distinctive pore characteristics. However, as the carbonization temperature increases, the pore space extends to a maximum. When the heat-treating temperature (HTT) increases to above 800° C., carbon cross-link reactions reduce the space between atoms and reduces porosity.

Activated carbons (ACs) are widely applied to a variety of industry applications, including the catalyst support, water purification, separation, and energy storage devices. The applications of ACs as electrodes for supercapacitors have attracted attention due to their high surface area, stability, and low cost. Typically, supercapacitors are classified as electric double layer (EDL) capacitors and pseudo capacitors. EDL capacitors can employ ACs to enhance capacity, as the excessive surface area of ACs enable the double-layer formation and subsequent high-power density. The performance of supercapacitors using ACs as electrode materials depends on the pore structure, pore size distribution, surface area, and surface functional groups of the ACs. There is a need or desire for an efficient activation method for preparing ACs with enhanced surface properties from lignin precursors.

Carbon dots, for example carbon quantum dots (CQDs) are nanoparticles having a size of <10 nm and a carbon core surface-passivated with various functional groups. CQDs have attracted attention due to their unique properties, such as tunable luminescence, easy fabrication, low cost, and low toxicity. CQDs been applied in various fields, including bioimaging, LED devices, biosensors, waste absorption, biomedicine and so on. The properties of CQDs depend on the material sources, synthesis approaches and conditions.

Diversity of carbon dots such as CQDs results from the variety of carbon precursors and synthetic methods, and CQDs are mainly classified into graphene quantum dots (GQDs), carbon nanodots (CNDs), and polymer dots (PDs). GQDs are mainly constituted by one-layer graphene debris or graphitic nanocrystal structure as carbon core. CNDs mainly possess the sp²-hybridized nanocrystalline embedded into amorphous carbon. PDs are aggregated polymer nanoparticles derived from polymer or monomers.

The synthesis of carbon dots, for example CQDs has been divided into top-down and bottom-up main categories. Top-down synthesis involves breaking the larger structures into smaller nano-carbon particles under harsh conditions, and electrochemical etching, chemical oxidation and laser ablation are commonly used methods. Bottom-up synthesis adopts a hydrothermal method, microwave assistance, or ultrasonic treatment to build carbon dots, such as CQDs from small molecules or polymer precursors. Although many have explored the potentials of CQDs, it has been challenging to elucidate the key factors controlling their varied physicochemical properties. Controlling size and, crystallinity, along with surface modification and heteroatom doping, needed to tune the luminescence of CQDs.

### SUMMARY

The present disclosure is directed to a method of making an improved lignin-derived activated carbon that is suitable for use in applications requiring high-value carbon materials. The disclosure is also directed to a reproducible and efficient method for producing carbon dots, for example carbon quantum dots and renewable carbons having targeted structure and properties, which can be used as electrodes in high performance devices such as supercapacitors and batteries. Embodiments of the disclosure include improved porous carbons for high performance supercapacitors, magnetic activated carbons for cationic dye adsorption, and lignin-derived carbon dots, for example carbon quantum dots with multiple color emissions.

In one embodiment, the present disclosure leverages an improved process-structure-property-performance relationship between lignin and the resulting high-value carbon materials to render the high-value carbon materials suitable for use in energy storage and environmental applications. Physical activation was conducted for developing activated carbons (ACs) from various lignin precursors and applied as electrodes for supercapacitors. It was discovered that ACs derived from softwood lignin achieved high surface area and excellent electrochemical performance. To further improve the electrochemical performance of developed ACs, carbon dots, for example carbon quantum dots (CQDs) were introduced and decorated on the surface of ACs. Benefiting from the hydrophilicity and ultrafine size of CQDs, the addition of CQDs led to an enhanced effective surface area and decreased ionic diffusion path, thus significantly improving the affinity of the electrodes toward aqueous electrolytes.

In order to further increase the surface area and optimize the porous structure of ACs, two-step and updated one-step chemical activation were conducted. These embodiments leverage the superior effects of one-and two-step potassium hydroxide (KOH) activation on the surface properties of lignin-based ACs. One-step activation produced ACs achieved ultrahigh surface area and high mesopore ratio, leading to ultrahigh capacitance and energy density of the fabricated supercapacitors (SCs). In comparison, two-step activation produced ACs had lower surface areas but high oxygen contents, leading to a hydrophilic surface. The hydrophilic surfaces of these ACs greatly decreased the internal resistance and increased the capacitance even at high current density, thus achieving high power density of the fabricated SCs.

In one embodiment, lignin-derived ACs also exhibited excellent adsorption performance for water purification, with the maximum adsorption capacity of 1,250 mg g⁻¹ of methylene blue (MB) adsorption. To improve the regeneration efficiency, magnetic ACs can be synthesized via an efficient co-carbonization and activation method. It was discovered that magnetite nanoparticles on the activated carbon surfaces improve their recycling ability.

In one embodiment, the disclosure provides an optimized synthesis method to produce lignin-derived carbon dots, for example carbon quantum dots (CQDs) with multicolor emissions from deep blue to red with narrow fluorescence spectra.

With the foregoing in mind, it is a feature and advantage of the invention to provide a method of preparing microporous activated carbon having a controlled surface area. The method includes the steps of:
providing a lignin including one or more of softwood lignin, hardwood lignin, and herbaceous lignin;
carbonizing the lignin at an elevated temperature of at least about 700° C. to produce a carbonized lignin; and
activating the carbonized lignin by mixing it with potassium hydroxide at a mass ratio of about 1:3 to about 1:5 and an elevated temperature of at least about 700° C. to yield the microporous activated carbon;
wherein the microporous activated carbon has a controlled surface area of about 50 to about 3500 m²/g and a controlled mesopore ratio of about 10% to about 80%.

It is also a feature and advantage of the invention to provide a method of preparing carbon dots, for example carbon quantum dots. The method includes the steps of:
providing a lignin;
carbonizing the lignin at an elevated temperature of at least about 900° C. in an inert environment for at least about 0.5 hour to produce a carbonized lignin;
physically activating the carbonized lignin at a temperature of about 700° C. to about 800° C. in the presence of humidity for at least about 0.5 hour to yield activated carbon;
exposing the activated carbon to carbon dioxide ta a temperature of at least about 700° C. for at least about 0.5 hour;
treating the activated carbon with concentrated nitric acid;
washing the activated carbon to obtain neutralized activated carbon;
mixing the neutralized activated carbon with hydrogen peroxide and solvent to yield a mixture;
heating the mixture to at least about 110° C. for at least about 1.5 hours to yield the carbon dots, for example carbon quantum dots; and
separating the carbon dots, for example carbon quantum dots from the mixture.

It is also a feature and advantage of the invention to provide a one-step method of preparing microporous activated carbon having a high surface area. The method includes:
providing a softwood lignin;
mixing the softwood lignin with potassium hydroxide at a mass ratio of about 1:3 to about 1:5 and an elevated temperature of at least about 700° C. to activate the lignin;
simultaneously carbonizing the lignin at the elevated temperature yield the microporous activated carbon;
wherein the microporous activated carbon has a controlled surface area of at least about 2500 m²/g and a controlled mesopore ratio of at least about 70%.

The foregoing and other features and advantages will become apparent from the following detailed description, read in conjunction with the accompanying figures and claims

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a plot showing surface area as a function of heat-treating temperature (HTT) used for carbonization for kraft softwood lignin. High surface areas are not produced during carbonization and generally require physical or chemical activation to achieve the desired pore structure.

FIG. 2 includes two plots showing two-dimensional C-H NMR plots of the aromatic region and the aliphatic region for kraft softwood lignin. The aromatic region (6-8 ppm/100-140 ppm) is shown in the left-hand plot. The aliphatic region (2.5-6 ppm/50-100 ppm) is shown on the right-hand plot.

FIG. 3 is a plot showing the FTIR spectra for kraft softwood pulp.

FIG. 4 is a plot showing the P NMR spectrum for kraft softwood pulp.

FIGS. 5A, 5, 5C and 5D are color plots showing the surface areas, micropore and mesopore distributions for ACs produced after one-step and two-step chemical activation processes using KOH. The abscissa of each plot shows the activation heating temperature in degrees Celsius and the mass ratio of kraft softwood lignin to KOH used for activation. FIG. 5B represents activation times ranging from 1.5-2.5 hours shown in the ordinate, while the remaining plots represent 2-hour activation times.

FIG. 6 is a color plot showing the surface areas, micropore and mesopore distributions for nine replicated ACs produced after one-step chemical activation at a temperature of 800° C. and 1:4 mass ratio for two hours.

FIG. 7 includes two color plots showing surface area versus pore width and pore volume versus pore width for the ACs obtained from kraft softwood lignin and activated using the one-step and two-step processes, using a temperature of 800° C. and 1:4 mass ratio for two hours.

FIGS. 8A-8D show four SEM images of ACs obtained from kraft softwood lignin and activated using the one-step process (FIGS. 8A, 8B) and two-step process (FIGS. 8A, 8B), using a temperature of 800° C. and 1:4 mass ratio for two hours.

FIG. 9 is a color plot showing the Raman spectra (shift versus intensity) for ACs obtained from kraft softwood lignin and activated using the one-step and two-step processes, using a temperature of 800° C. and 1:4 mass ratio for two hours.

FIGS. 10A-D show four color plots showing XPS measurements (binding energy versus counts) for the ACs obtained from kraft softwood lignin and activated using the one-step process (FIGS. 10A, 10C) and the two-step process (FIGS. 10B, 10D), using a temperature of 800° C. and 1:4 mass ratio for two hours. FIGS. 10A, 10B show the XPS spectra of C (1s peak) while FIGS. 10C, 10D show the XPS spectra of O (1s peak).

FIG. 11A-11D show color plots of galvanic charge discharge (GCD) and current voltage (CV) measurements for the ACs obtained from kraft softwood lignin and activated using the one-step process (FIGS. 11A, 11C) and the two-step process (FIGS. 11B, 11D), using a temperature of 800° C. and 1:4 mass ratio for two hours. For FIGS. 11A, 11D the electrodes were charged and discharged at 0.2 A/g. for FIGS. 11C, 11D the electrodes were observed at different scan rates.

FIGS. 12A, 12B show two color plots of electronic impedance spectroscopy (EIS) for the ACs obtained from kraft softwood lignin and activated using the one-step and two-step processes, using a temperature of 800° C. and 1:4 mass ratio for two hours. FIG. 12A is a Nyquist plot of the fabricated electrodes at open circuit voltage, where an equivalent circuit was proposed for impedance behavior within a frequency range of 100 kHz to 1 Hz. FIG. 12B is a Randle's plot of different capacitors at open circuit voltage.

FIGS. 13A, 13B show color plots of (13A) current densities versus variation of specific capacitance of electrodes and (13B) Ragone plots of power density versus energy density, for supercapacitors (SCs) made using ACs obtained from kraft softwood lignin and activated using the one-step and two-step processes, using a temperature of 800° C. and 1:4 mass ratio for two hours.

FIG. 14 is a color plot showing the power density versus energy density of supercapacitors with various known electrodes.

FIGS. 15A, 15B show two color plots of linear Langmuir models fitted with equilibrium data for ACs produced using the one-step and two-step activation methods, for methylene blue (MB) absorption. FIG. 15A shows results for the one-step activation method, for ACs activated at 800° C., using mass ratios of 1:3 and 1:4 kraft softwood lignin to KOH, and times of 1.5 to 2.5 hours. FIG. 15B shows results for the two-step activation method, for ACs activated at 700° C. to 900° C., using mass ratios of 1:3 and 1:4 kraft softwood lignin to KOH, and times of 1 to 2 hours.

FIG. 16A-16F show fluorescence excitation emission mapping spectra for various carbon dots, for example carbon quantum dots (CQDs) described in the specification as (16A) H-AC-1.5h, (16B) H-AC-2h, (16C) H-AC-3h, (16D) H-AC-4h, (16E) H-AC-8h and (16F) H-AC-16h. The CQDs were made using a physical activation process described herein, and the number of hours indicates the activation processing times.

FIG. 17 is a color plot showing the excitation spectra (normalized intensity versus wavelength) for the CQDs represented in FIGS. 16A-16F.

FIG. 18 is a color plot showing the PL spectra (emission and excitation spectra) for the CQD sample designated as H-AC-8h, with an embedded photo image.

FIGS. 19A-19C include color images showing the three-dimensional emission-excitation spectra for the CQD sample identified as H-AC-1.5h at (19A) high, (19B) medium, and (19C) low concentrations.

### DETAILED DESCRIPTION

The following detailed description will illustrate the general principles of the invention, examples of which are additionally illustrated in the accompanying drawings. In the drawings, like reference numbers indicate identical or functionally similar elements.

Except in the working examples, or where otherwise explicitly indicated, all numbers in this description indicating amounts, parts, percentages, ratios, and proportions of material, physical properties of material, and conditions of reaction are to be understood as modified by the word “about.” “About” as used herein means that a value is preferably +/−5% or more preferably +/−2%. Unless indicated otherwise, percentages for concentrations are typically % by mass.

In one embodiment, the disclosure is directed to a method of preparing activated carbon, such as microporous activated carbon (AC) having a controlled, often high surface area and a controlled, often high mesopore ratio. The method includes the step of providing a lignin including one or more of softwood lignin, hardwood lignin, and herbaceous lignin. The lignin is then carbonized at an elevated temperature of at least about 700° C. to produce a carbonized lignin. This is called the “activation” or “carbonization” step and is sometimes referred to as the “pyrolysis” step. The method also includes an “activation” step which can be performed simultaneously with the carbonization step in a “one-step” method or separately from the carbonization step in a “two-step” method.

The activation step can be accomplished by mixing the carbonized lignin with potassium hydroxide at a mass ratio of carbonized lignin to potassium hydroxide of about 1:3 to about 1:5 an elevated temperature of at least about 700° C. for a period of time explained herein, to yield the mesoporous activated carbon. Overall, the methods can be used to provide mesoporous activated carbon having a controlled surface area of about 50 to about 3500 m²—/g and a controlled mesopore ratio of about 10% to about 80%. When the one-step activation process (described below) is used, the mesoporous (e.g., microporous) activated carbon can, in some embodiments, have a surface area of at least about 2500 m²/g and a mesopore ratio of at least about 70%. When the two-step activation process (described below) is used, the microporous activated carbon can, in some embodiments, have a surface area of at least about 1200 m²/g and a mesopore ratio of at least about 25%.

Based on the experimental results described herein, softwood lignin has been found to be particularly suitable in achieving the surface area, mesopore ratio, and other desirable properties described herein, and to achieve the desirable properties with sufficient controlled uniformity to render the ACs suitable for many high value applications that have previously been difficult to reach, due to inconsistencies in the ACs produced using prior art processes. Kraft softwood lignin has been found to be particularly desirable. As explained above, softwood has a higher lignin content (about 28%) compared with hardwood (about 20%) and grass (about 15%). This makes the use of softwood lignin more efficient and economical. Additionally, the kraft process has many advantages including low energy requirements, favorable economics, excellent chemical recyclability, coproduct generation, the ability to pulp virtually any lignocellulosic feedstocks, and high pulp strength.

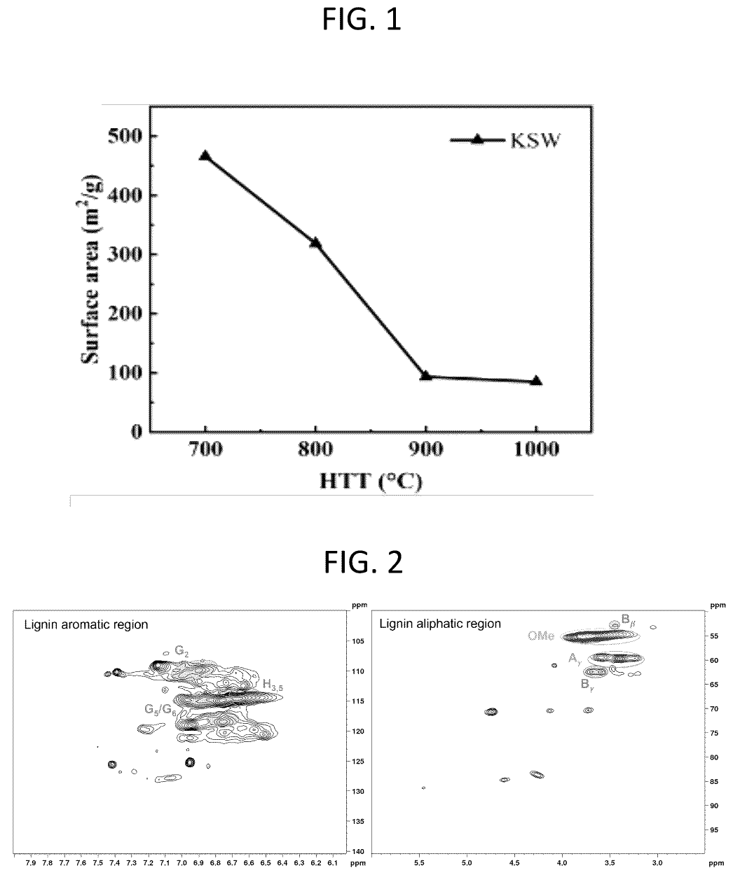

The carbonization step involves heating the lignin to a temperature of at least about 700° C., suitably for a time sufficient to achieve pyrolysis of the lignin. The optimum temperature and times can vary depending on whether the one-step method (in which the carbonization and activation occur in a single step) or the two-step method (in which the carbonization occur in separate steps) is being practiced. Referring to FIG. 1, carbonization alone will not yield a very high surface area or mesopore ratio. To the contrary, higher carbonization temperatures resulted in progressively lower surface areas as the temperature was increased from 700° C. to 900° C., with some leveling between 900° C. and 1000° C.

When the one-step method is used, it has been discovered that the desired combination of high surface area and mesopore ratio occurs using heat treatment of about 700° C. to about 900° C., suitably about 750° C. to about 850° C., or about 800° C., for a time period of about 1 hour to about 3 hours, suitably about 2 hours, with simultaneous activation. The activation can be made to occur simultaneously by mixing the lignin with potassium hydroxide (KOH) using a mass ratio of lignin to KOH of about 1:3 to about 1:5, suitably about 1:4. The mixing can occur prior to or during heating and suitably occurs prior to heating. In one embodiment, the mixing can be accomplished by providing KOH in an aqueous solution and agitating the mixture to ensure that the lignin is impregnated with the KOH to the maximum extent possible. The KOH can be provided in any suitable molar concentration. KOH has a solubility of up to 11.7 moles per liter of water, and an exemplary concentration of about 6 moles KOH per liter is suitable for mixing and stirring the lignin with the KOH.

Because the one-step method performs activation simultaneously with carbonization, the activation times and temperatures are the same as the carbonization times and temperatures. The activation heat treatment heat treatment occurs at about 700° C. to about 900° C., suitably about 750° C. to about 850° C., or about 800° C., for a time period of about 1 hour to about 3 hours, suitably about 1.5 to about 2.5 hours, or about 2 hours. In one embodiment, the simultaneous activation and carbonization can occur in an inert atmosphere, of example, nitrogen. In one embodiment, the simultaneous activation and carbonization can occur inside a furnace, such as a steel tube furnace, or in another suitable venue with the inert gas being provided at a desired flow rate.

Using the foregoing one-step method, it has been discovered that Activated carbons (ACs) having a high BET surface area (Brunauer, Emmett and Teller) of about 2000 m²/g to about 3500 m²/g can be produced. The BET surface area can be measured using ATSM D3663-20, entitled “Standard Test Method for Surface Area of Catalysts and Catalyst Carriers,” which is incorporated herein by reference. In some embodiments, the BET surface area can range from about 2500 m²/g to about 3500 m²/g, and can be about 3000 m²/g to about 3500 m²/g.

The ACs produced using the one-step method can also be characterized by mesopore ratio and micropore ratio. A mesopore is a pore with a diameter of 2-50 nm (IUPAC), while a micropore has a smaller diameter less than 2 nm. The mesopore ratio is the percent of the BET surface area that is attributable to mesopores. The micropore ratio is the percent of the BET surface area that is attributable to micropores. The mesopore and micropore ratios can be determined using ASTM D3363-20, where micropore volume is total pore volume less mesopore volume. Using the foregoing one-step method, ACs can be produced having a mesopore ratio of at least about 65%, or at least about 70%, or at least about 75%, or about 65% to about 85%, or about 70% to about 80%.

When the two-step method is employed, the carbonization step occurs first. Carbonization can be accomplished by pyrolyzing the lignin in an inert (e.g., nitrogen) atmosphere at a temperature of about 900° C. to about 1100° C., suitably about 950° C. to about 1050° C., or about 1000° C., and for a period of about 0.5 to about 1.5 hour, suitably about 1 hour. The carbonization can occur in a furnace, such as a stainless-steel tube furnace, or in another suitable venue, with inert gas being provided at a desired flow rate. The carbonized lignin can then be ground into char using ball milling or another suitable grinding technique. The carbonized char can be separated from the grinding balls using sieves or another suitable technique.

In the second (activation) step of the two-step method, the carbonized char can be mixed with KOH at a mass ratio of carbonized char to KOH of about 1:3 to about 1:5, suitably about 1:4. Again, the KOH can be provided in an aqueous form in a molar concentration of up to about 11.7 moles/liter, suitably about 6 moles/liter. The mixing can be accomplished by mixing the aqueous KOH solution and agitating the mixture to ensure that the lignin is impregnated with the KOH to the maximum extent possible. The mixture can then be placed in the tube furnace or another suitable venue using a desired flow rate of inert gas such as nitrogen, to provide an inert environment for activation. Suitable activation temperatures for the two-step method are from about 700° C. to about 900° C., suitably about 750° C. to about 850° C., or about 800° C. These activation temperatures are about the same as for the one-step method. The activation times at the elevated furnace temperature can range from about 0.5 to about 2.5 hours, suitably about 1 to about 2 hours, or about 1.5 hours.

It has been discovered that the two-step method yields ACs with lower surface areas and lower mesopore ratios than the one-step method. When the two-step method is used, the resulting ACs can, in some embodiments, have a BET surface area of at least about 800 m²/g, or at least about 1000 m²/g, or at least about 1200 m²/g, and up to about 2000 m²/g or up to about 1800 m²/g, or up to about 1500 m²/g. The resulting ACs may have a mesopore ratio of at least about 10%, or at least about 15%, or at least about 20%, or at least about 25% and up to about 30%, with a range of about 20% to about 30% or about 25% to about 30% being desirable. As explained above, the process parameters can also be tailored to control the surface area to as low as about 50 m²/g and/or to control the mesopore ratio to as low as about 10%.

The present disclosure is also directed to a method of preparing carbon dots, for example carbon quantum dots. A lignin is provided, which can be one or more of softwood lignin, hardwood lignin, and herbaceous lignin, and suitably includes a softwood lignin, which can be a kraft softwood lignin. The lignin can be carbonized by heating in a steel tube furnace or another suitable venue which can be blanketed with an inert gas such as nitrogen. The heating temperature can be about 900° C. to about 1100° C., and is suitably about 950° C. to about 1050° C., or about 1000° C. The heating time can be at least about 0.5 hour and can range from about 0.5 hour to about 2 hours, or from about 0.5 hour to about 1 hour. In one embodiment, the heating can occur at a relatively slow heating rate of about 5° C. to about 20° C. per minute, suitably about 10° C. per minute. When the furnace reaches the target temperature, for example 1000° C., that temperature can be maintained for at least about 0.5 hour to complete the carbonization.

The carbonized lignin can then be physically activated using heat combined with steam, carbon dioxide, or both. The heating temperature for physical activation can range from about 700° C. to about 800° C. and can be maintained for about 0.5 hour to about 2 hours, suitably about one hour. In one embodiment, the carbonized lignin can be physically activated by first exposing it to humidity (steam) at a temperature of about 700° C. for a period of at least about 0.5 hour, then exposing it to carbon dioxide at a temperature of about 800° C. for at least about 0.5 hour.

The resulting activated carbon can then be mixed with concentrated nitric acid (for example, 8 M nitric acid) and can be stirred for a period of time, for example, about 4 to about 6 hours. The resulting material can then be washed, suitably using deionized water, to yield neutralized activated carbon. The neutralized activated carbon can then be treated with hydrogen peroxide. In one embodiment, the hydrogen peroxide can be mixed with a solvent such as dimethyl formamide (DMF) in an exemplary 1:2 volume ratio. The neutralized activated carbon can be mixed and stirred in the hydrogen peroxide solution for a time period of about 1 to about 30 minutes, suitably about 3 to about 20 minutes, or about 5 to about 10 minutes. Alternatively, the lignin, pyrolyzed lignin, and lignin based activated carbons, can be used as precursors to be mixed with DMF and hydrogen peroxide for producing carbon dots, for example carbon quantum dots. The mixture can then be transferred to an autoclave and can be heated to a temperature of at least about 100° C., suitably about 110° C. to about 180° C., for a time period ranging from about 1.5 hours to about 16 hours.

The resulting carbon dots, for example carbon quantum dots (CQDs) can be separated from the mixture using any suitable technique. In one embodiment, the CQDs can be separated from the mixture using a centrifuge technique, such as an ultra-centrifuge operating at 20 Kg centrifugal force for a time period of about 0.5 hour or greater if necessary. In order to further purify the CQDs, flash chromatography can be performed using a mixture of ethanol and water as eluent, for example, using a varying volume ratio of about 10:1 to about 1:10.

The features and advantages will be further illustrated in the following Examples, read in conjunction with the drawings.

### EXAMPLES

### Preparation of Lignin-Derived Activated Carbons

High surface area Activated Carbons (HACs) were prepared via one-step and two-step processes. The nomenclature HAC-1 and HAC-2 refers to an activated carbon produced via the one-step and two-step methods, respectively. For two-step produced ACs, Kraft softwood (KSW) lignin was first carbonized in an inert N₂ atmosphere (˜2.5 L min⁻¹ flow rate) in a stainless-steel tube furnace at 1000° C. for 1 hour. The carbonized samples were grinded by ball-milling (PM100 RETSCH model) and separated from the grinding balls with sieves to obtain the carbonized lignin char. The carbonized lignin was mixed with KOH at mass ratios of 1:3 and 1:4, respectively, and placed into the tube furnace for chemical activation in the N2 environment at 700, 800, and 900° C. for 0.5 hour. For the one-step produced ACs, the KSW lignin was directly mixed with KOH at mass ratios of 1:3 and 1:4 and processed in the steel tube furnace for simultaneous carbonization and chemical activation. After activation, the activated carbon samples were washed with deionized water, and then oven-dried at 105° C. for 2 hours. For both processes, a variety of processing conditions were explored. For the one-step HAC-1, it was discovered that the optimal processing conditions used a temperature of 800° C. for the combined carbonization and activation, a lignin to KOH ratio of 1:4 and a processing time of 2 hours. For the two-step HAC-2, it was discovered that the same optimal processing conditions worked best for the activation step, namely a temperature of 800° C., a lignin to KOH ratio of 1:4 and a processing time of 2 hours.

### Materials Characterization

Gel permeation chromatography (GPC) analysis was used to determine the molecular weight (Mw, Mn) and molar-mass dispersity (Ð_{M}) index of the lignin samples. Phosphorous-31 nuclear magnetic resonance (³¹P-NMR) measurements were conducted with a Varian 400-MR spectrometer. Two-dimensional (2D) carbon observed, proton broadband decoupled nuclear magnetic resonance (¹H-¹³C NMR) spectra were conducted on a Bruker Avance III 500-Hz NMR spectrometer. The morphology of ACs were characterized by scanning electron microscopy (SEM, Zeiss EVO). The surface functionalities of ACs were analyzed via X-ray photoelectron spectroscopy (XPS, Fison VG ESCA210) measurement. CHN elemental analysis was performed by combustion analysis (Perkin Elmer). The surface characteristics were obtained by TriStar 3000 volumetric adsorption analyzer (Micromeritics Instrument Co.). Raman spectroscopy was conducted with a 785 nm laser (Renishaw, 50% power). The samples were scanned within the range of 300-3200 cm⁻¹.

### Electrochemical Performance Tests

Slurries were prepared containing activated carbons (94.0 wt. %), polyvinylidene fluoride (5.0 wt. %, Kynar) and black carbon (1.0 wt. %, Super C65) in N-methyl-2-pyrrolidone (NMP) solvent. The electrodes were prepared by coating the slurry on stainless-steel substrates (2×1 cm²). Electrochemical performance of prepared electrodes was tested using a three-electrode system with a 1-molar H₂SO₄ solution as the electrolyte. The impedance spectra were taken with frequency ranging from 100 kHz to 1 mHz.

### Adsorption of Methylene Blue Dye

10 mg activated carbons were added into 10 mL methylene blue (MB) solution with different MB concentrations (500-2000 mg L⁻¹). The mixed solutions were shaken on an incubator at room temperature for 48 hours to reach equilibrium. Then the mixtures were centrifuged at 10000 rpm for 5 min. The upper supernatant was collected for adsorption measurements via UV-vis Spectroscopy (Shimadzu Corporation) at 660 nm. MB standard calibration curve was developed from a series of known MB dye solutions. The dye adsorption capacity was calculated using the following equation:

$${q}_{e} = \frac{( {C}_{0} - {C}_{e} ) V}{m} \qquad ( 1 )$$

where C₀ is the initial MB concentration (mg L⁻¹), Cₑ is the MB concentration at equilibrium (mg L⁻¹), m is the weight of the used activated carbons (g), V is the solution volume.

### Results and Discussion

The results are organized into four sections: (i) chemical characteristics of the lignin feedstock, (ii) structural and chemical characteristics of the activated carbons, (iii) electrochemical performance and (iv) methylene blue adsorption performance.

### Characteristics of the Lignin Feedstock

The feedstock used in these examples was kraft softwood (KSW) lignin. The composition and elemental analysis are shown in Table 1. KSW lignin has high purity (95.96%). The ash content (3.86%) usually refers to the inorganic and mineral contents that come from biomass, which is highly related to the biomass and isolation methods. The polydispersity of the molecular weight is about 2 for KSW lignin, indicating uniformity of molecular weight distribution. The presence of sulfur in KSW is a result of the use of sulfuric acid in the kraft pulping process.

TABLE 1
Composition, GPC, and elemental analysis of KSW lignin.

| Purity analysis (%) | | Molecular weight | | | Elemental analysis (%) | | | | |
|---|---|---|---|---|---|---|---|---|---|
| ASL^{a} + AIL^{b} | Ash | Mn | Mw | Molar-mass dispersity | C | H | N | S | O |
| 95.96 | 3.86 | 1705 | 3577 | 2.098 | 62.07 | 5.64 | 0.44 | 1.65 | 30.20 |

^{a}Acid-soluble lignin.
^{b}Acid-insoluble lignin.

The monomer distribution of lignin is highly related to the plant species and isolation methods. Moreover, the monomer distribution impacts the structure of the resulting carbonized char. To examine the chemical structure and monomer distribution of the KSW lignin, 2D ¹³C-¹H NMR was conducted. The aromatic region (6.0-8.0 ppm/100-140 ppm) is shown in FIG. 2, left. For the KSW lignin, the aromatic region mainly contains guaiacyl (G) unit (˜78.2%) and H monomer (˜21.8%). The aliphatic region (2.5-6.0 ppm/50-100 ppm) is shown in FIG. 2, right. As shown, the aliphatic linkages of KSW lignin are dominated by methoxy (OMe) and γ-hydroxylated (A_{γ}) groups, with a small amount of β-5′ phenylcoumaran (B_{γ} and B_{β}) groups.

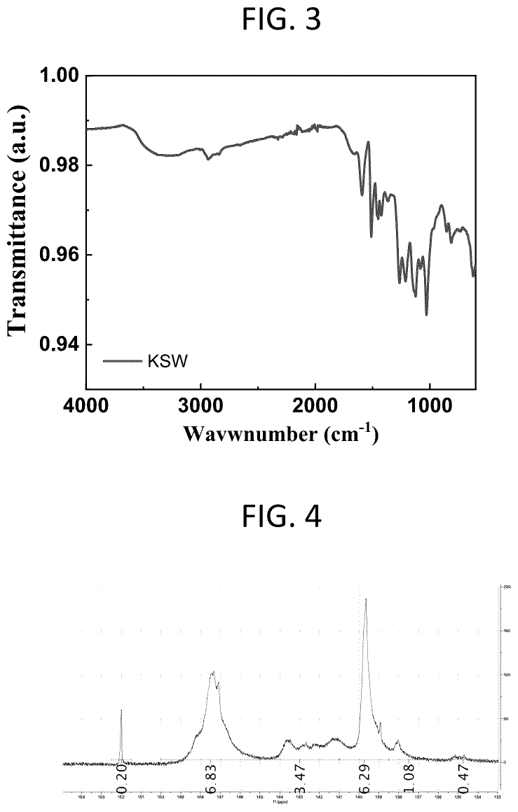

The presence of functional groups in the lignin also impacts the chemical composition of the resulting carbonized lignin char. FTIR spectra of the KSW lignin was obtained and is shown in FIG. 3. The broad peak around 3300 cm⁻¹ corresponds to the stretch vibrations of phenolic and aliphatic O—H groups. The peaks around 1600, 1510, and 1440 cm⁻¹ represent the —C═C aromatic stretching vibrations. The bands around 1260 and 1210 cm⁻¹ represent the C—C, C—O and C═O stretching of G units. The peaks around 1130 and 1030 cm⁻¹ should be attributed to the C—O stretching in ester methoxy groups and β-O-4 links.

Hydroxyl groups are crucial to the thermal properties of lignin. ³¹P NMR (shown in FIG. 4) was applied for characterizing the hydroxyl groups. and the quantitative results are shown in Table 2. The significant peak at a chemical shift of 6.29 corresponds to the guaiacyl OH groups. The ³¹P NMR results are also consistent with the 2D NMR, which returned a monomer distribution about 78% guaiacyl (G) unit.

TABLE 2
Hydroxyl group contents of KSW lignin obtained by ³¹P NMR

| | Chemical shift | Content (mmol/g |
|---|---|---|
| Lignin functional group | (ppm) | lignin) |
| Internal standard | 152.5-151.5 | 0.20 |
| Aliphatic OH groups | 150-145 | 6.83 |
| C₅ substituted OH groups | 145-141 | 3.47 |
| Guaiacyl OH groups | 141-138.5 | 6.29 |
| p-OH phenyl OH groups | 138.5-136.5 | 1.08 |
| COOH groups | 136-133.5 | 0.47 |

### Characterization of Lignin-Derived Activated Carbons

BET surface areas and porous structures

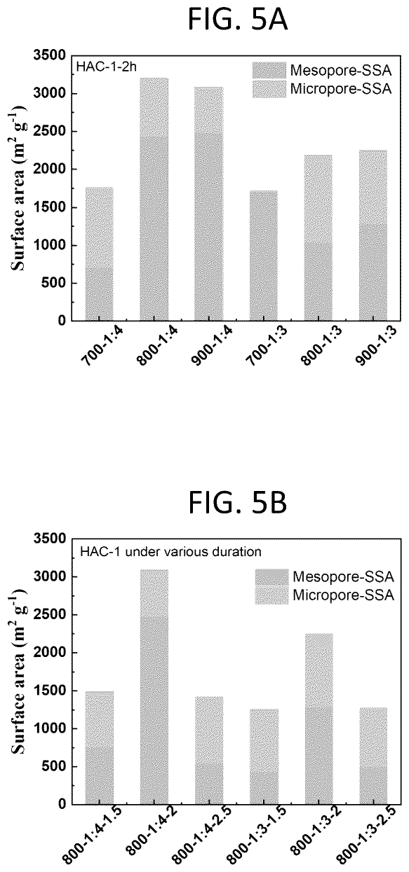

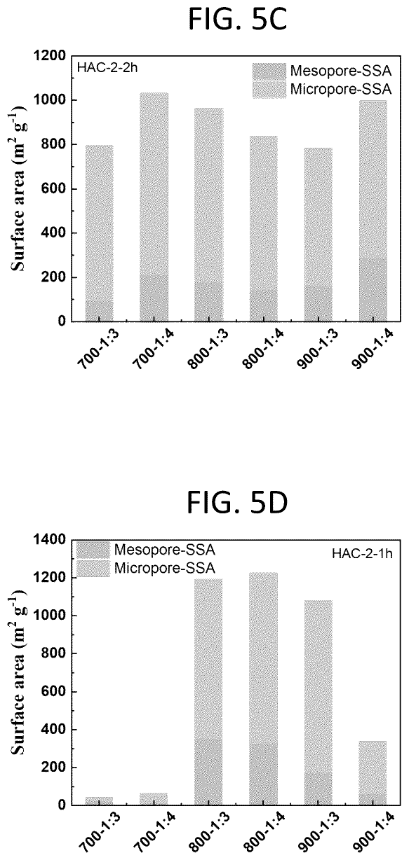

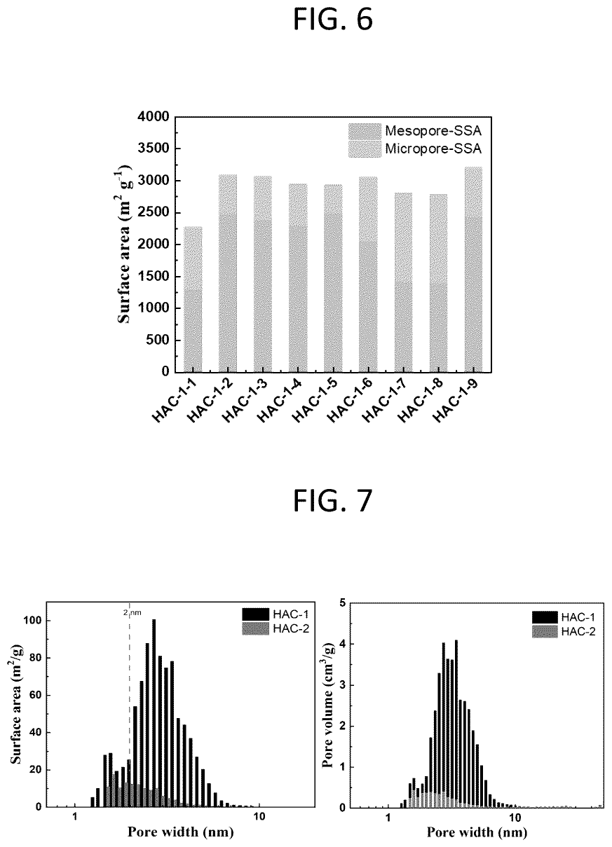

One-and two-step activation methods were performed under various conditions and the surface areas and mesopore distributions of the produced samples are shown in FIGS. 5A-5D. The one-step method produced samples having higher surface areas and mesopore ratios compared with two-step method samples. The highest surface area of ACs after one-step activation was obtained with the mass ratio of 1:4 lignin to KOH under 800° C. for 2 hours. The optimum conditions for the two-step activation were a 1:4 mass ratio under 800° C. for 1 hour. As reactions during the one-step method is more intense and the process is relatively hard to control, the fluctuation of the surface areas of one-step produced samples are relatively larger than that two-step produced samples. The replicated results of HAC-1 are shown in FIG. 6. As shown in Table 3, the BET surface area of HAC-1 reached as high as 3,206.51 m² g⁻¹, which was 2.65 times the highest surface area of HAC-2 (1,209.06 m² g⁻¹). In addition, HAC-1 achieved a mesopore ratio of 75.84%, while the mesopore ratio of HAC-2 reached only about 26.96%. Activated carbons are the most popular materials applied for electrodes for supercapacitors as well as adsorbents for water purification. However, usually the higher surface area is correlated with a more tortuous porosity, which leads to long diffusion distances and high ionic diffusion resistance. A high mesopore ratio benefits the diffusion of ions. FIG. 7 shows the density functional theory (DFT) pore size distributions of the two samples, measured using ASTM D3663-20. As shown, mesopore volume was predominant for the HAC-1 sample. There were obvious increases of the surface area and pore volume in the mesopore region of HAC-1 compared with HAC-2, while the micropores contribute similarly to the surface area and pore volume for both samples.

TABLE 3
Pore structures of one-step and two-step ACs prepared from KSW lignin

| | Specific surface area | | | | | |
|---|---|---|---|---|---|---|
| | | Surface Area from | Surface Area from | Pore volume | | |
| Carbon | S_{BET} | micropores | mesopores | Vₜ | V_{micro} | Vₘₑₛₒ |
| type | (m² g⁻¹) | (%) | (%) | (cm³ g⁻¹) | (%) | (%) |
| HAC-1 | 3206.51 | 24.16 | 75.84 | 2.20 | 25.90 | 74.10 |
| HAC-2 | 1209.06 | 73.04 | 26.96 | 0.76 | 61.70 | 38.30 |

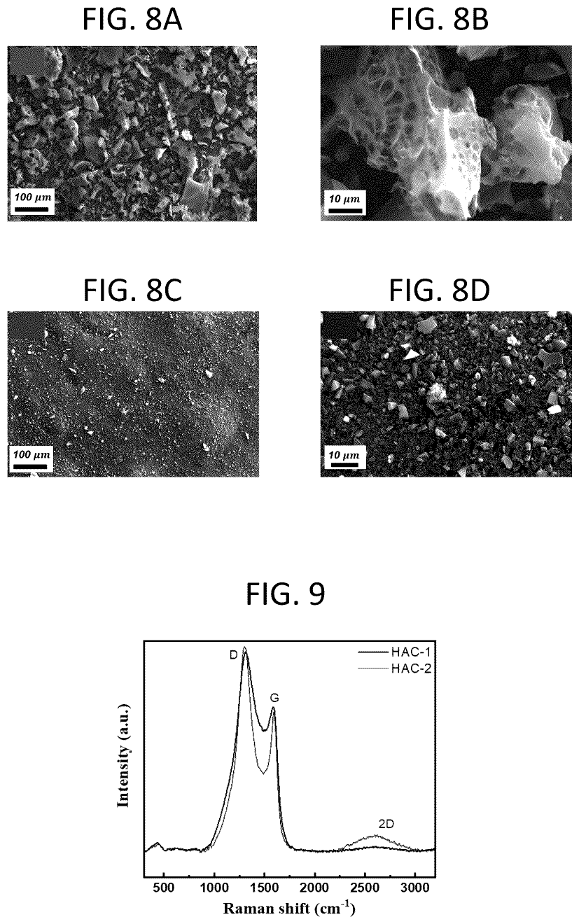

Scanning electron microscopy (SEM) images of HAC-1 and HAC-2 are illustrated in FIGS. 8A-8D. According to FIGS. 8A, 8C, the particle size of HAC-1 is obviously larger than that of HAC-2, as the HAC-2 were produced after two-steps and ball milling was conducted twice, after both carbonization and activation. HAC-1 was only ball milled once after one-step activation. As shown in FIGS. 8B, 8D, more porosity was present with HAC-1 than HAC-2 under high magnification.

Raman spectroscopy was performed to characterize the physical structure of the one-and two-step activation produced ACs. As displayed in FIG. 9, both samples exhibited strong D bands (around 1310 cm⁻¹) and G bands (around 1590 cm⁻¹). Generally, the D band represents the sp3 carbons, referring to the disordered and defects carbon structures, and G band originates from sp2 carbons, which is associated with the ordered graphitic structure. It is generally recognized the I_{D}/I_{G} ratio is indicative of the graphitization level of the carbon materials. The I_{D}/I_{G} of HAC-1 is 1.47 for HAC-1, and 1.38 for HAC-2. The higher I_{D}/I_{G} ratio of HAC-1 indicates the more amorphous structure and defects, which results from the higher porosity of the HAC-1 sample compared with the HAC-2 sample. In addition, it is apparent that the peaks of the HAC-2 sample are much narrower than those of the HAC-1 sample, indicating the greater graphitization of HAC-2 sample. The broad peaks in HAC-1 are correlated to the distribution of clusters with different orders and dimensions. There was a slight shift of the D and G peak positions between the two samples, related to the structural changes at atomic level. The D band position down shifted from 1311 to 1302 cm⁻¹ from HAC-1 to HAC-2, indicating the formation of the aromatic clusters with larger size under two-step activation. The G band position shifted from 1586 to 1596 cm⁻¹ from HAC-1 to HAC-2, reflecting an increase in functional groups bonded to the surfaces of the HAC-2 samples.

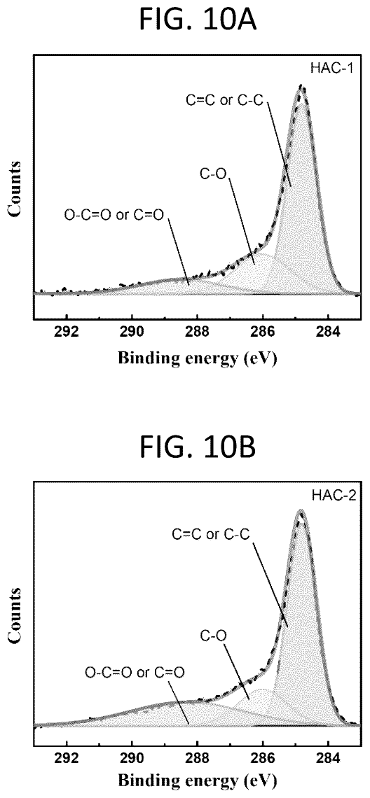

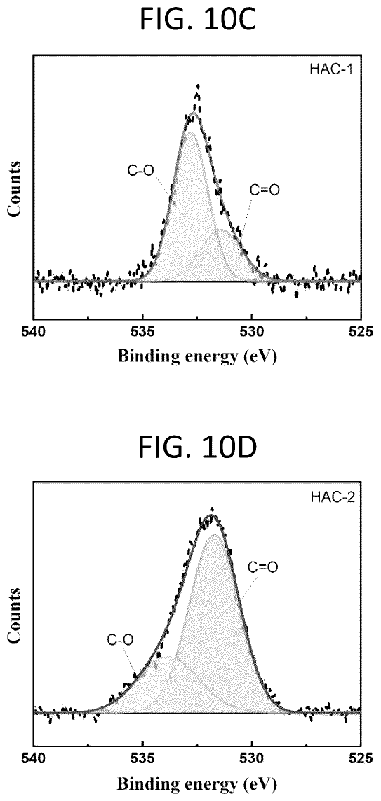

To further examine the surface functionalities of both HAC-1 and HAC-2 samples, X-ray photoelectron spectroscopy (XPS) measurements were conducted. XPS surface elemental analysis (Table 4) shows that HAC-1 and HAC-2 contained O/C ratios of 18.1 and 7.3, respectively. As shown in FIGS. 10A, 10B, the C 1s peaks were deconvoluted by a multiple Gaussian function into three peaks centered at 284.8 eV (C═C or C—C), 286.0 eV (C—O) and 288.5 eV (O—C═O or C═O). It is apparent that the adsorption intensity of O—C═O or C═O peak in the HAC-2 sample was enhanced, occupying 26.0% of the total integration area. The HAC-1 sample contained more C—O groups, occupying 25.0% of the total integration area. To further clarify the distribution of oxygen functional groups on the surface of two samples, the O 1s peaks were decomposed into two peaks and represent C═O (˜531.5 eV) and C—O (˜533.0), which refer to the carboxyl/carbonyl and hydroxyl groups, respectively. As shown in FIGS. 10C, 10D, the C—O is predominant in HAC-1 sample, occupying 61.2% of the total integration area, while HAC-2 primarily contains C═O, occupying 72.2% of the total integration area. The C═O bonds, which refer to the carboxyl and carbonyl groups, have higher polarity compared with C—O (hydroxyl groups), thus leading to the high hydrophilicity of HAC-2 sample. Accordingly, HAC-2 contains more surface functionalities with higher O/C ratio, which is in consistent with Raman results.

TABLE 4
Elemental analysis by XPS and CHN measurements

| | |
|---|---|
| HAC-1 | HAC-2 |

XPS surface elemental analysis

| | | |
|---|---|---|
| O/C | 7.3 | 18.1 |

CHN elemental analysis

| | | |
|---|---|---|
| O/C | 8.6 | 29.2 |

As XPS is a surface characterization technique, Table 4 also shows the CHN measurements for clarifying the O/C ratio for the bulk materials. As shown in Table 4, the O/C ratio of HAC-2 increased from 18.1 to 29.2, indicating the oxygen not only existed on the surface of carbons, but also doped into the porous structure, which would be beneficial to the electrical conductivity of the HAC-2 sample.

### Electrochemical Performance

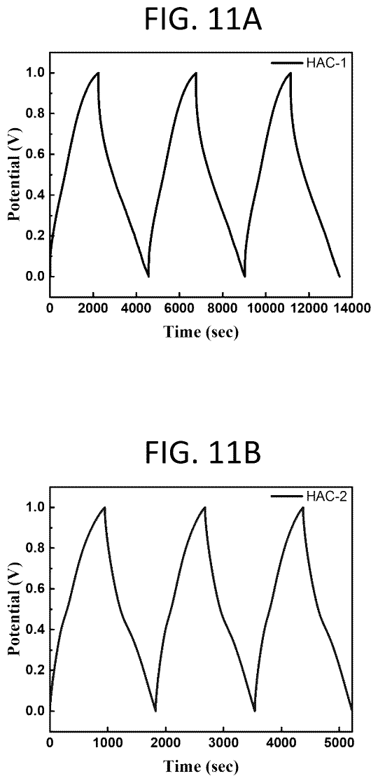

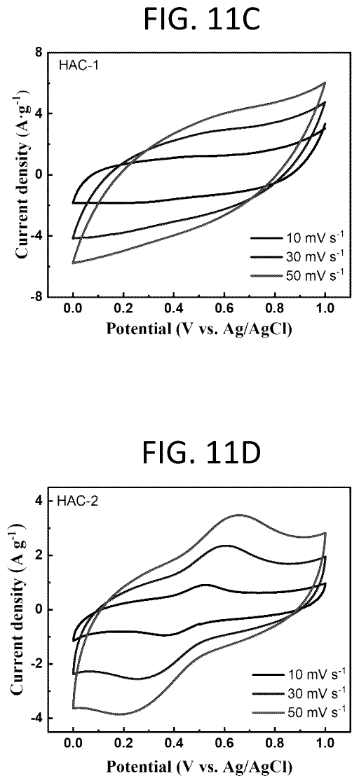

To test the electrochemical performance of one- and two-step activation produced ACs, the capacitances were measured by galvanostatic charge discharge (GCD) measurements within a potential window of 0-1.0 V and at a current density of 0.2 A g⁻¹. As shown in FIGS. 11A, 11B, the charging and discharging times of an HAC-1 electrode were much higher than that of an HAC-2 electrode, confirming the higher capacitance of HAC-1 electrode at low current density due to its much higher surface area. The HAC-2electrode shows more obvious shoulders at 0.4-0.5 V, which are attributed to the pseudocapacitance from the redox reactions of the oxygen functional groups. Current-Voltage (CV) curves of HAC-1 and HAC-2 are shown in FIGS. 11C, 11D. The HAC-2 electrode shows both pseudo capacitor behavior and EDL capacitor behavior, while the HAC-1 electrode demonstrates more clearly the rectangular shape of the CV curve, characteristic of the EDL capacitor. The more obvious current leakage with increasing sweep speed in HAC-1 sample indicates that HAC-1 should have a relatively larger equivalent series resistance.

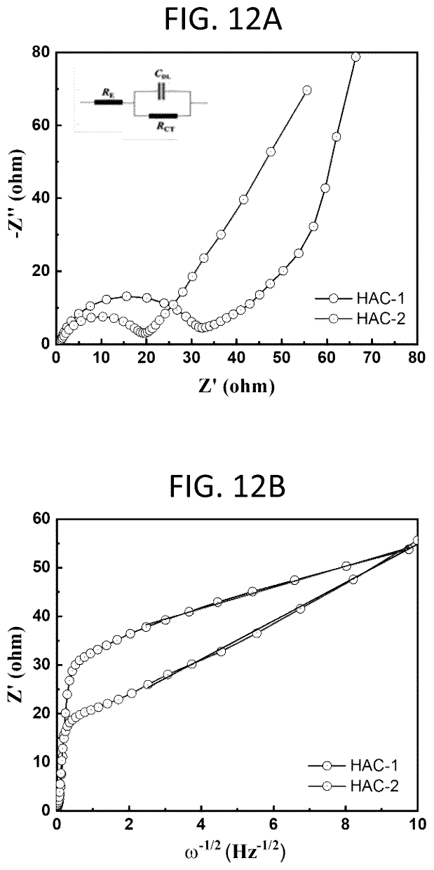

To further evaluate the ion diffusion and electronic transport within the electrodes, electrochemical impedance spectroscopy (EIS) was performed. FIG. 12A shows the Nyquist plot of the fabricated electrodes. In the high frequency region (100 kHz-1 Hz), the intersection of the semicircle with the x-axis can be attributed to the internal resistance, including the electrolyte resistance (Rₑ) and the charge transfer resistance (R_{ct}) at the interface between the electrode and electrolyte. The resistance was calculated based on the equivalent circuit model (shown in the insert of FIG. 12B) and analyzed with Z-view software. The difference in the electrolyte resistance is negligible as the same electrolyte was used for both the HAC-1 and HAC-2 samples. However, the R_{ct} were calculated to be 33.8 and 20.6 Ω for HAC-1 and HAC-2, respectively. The much higher charge transfer resistance of HAC-1 can be attributed to its much higher surface area, more complex porosity, and more hydrophobic structure, resulting in the higher charge transfer resistance within the pore structure. In the low frequency region (1 Hz-1 mHz), the inclined line can be assigned to the Warburg impedance (Z_{D}), which corresponds to the ion diffusion process within the porous structure.

The more vertical line suggests a lower diffusion resistance. For the HAC-1 electrode, the diffusion resistance gradually decreased with decreasing frequency, because the pore structure becomes more significant for the diffusion process at low frequency. The diffusion resistance of HAC-1 was also reduced due to its high mesopore ratio. FIG. 12B presents the “Randles plot” for both electrodes to detail the diffusion process of protons within the porous structures at low frequencies. Here, k_{W} represents the Warburg coefficient and was obtained from the slope of the Randles plots. The diffusion coefficient (D) can be calculated based on the follow equation:

$${k}_{W} = \frac{R T}{{n}^{2} {F}^{2} A \sqrt{2}} ( \frac{1}{{D}^{1 / 2} {C}^{*}} )$$

where n is the charge-transfer number, A is the electrode surface area, and C* is the ionic concentration, and all those parameters are already known. The calculated diffusion coefficients were 4.66×10⁻¹⁰ and 1.43×10⁻¹⁰ cm² s⁻¹ for HAC-1 and HAC-2, respectively. The diffusion coefficient of HAC-1 was three times higher than for HAC-2, revealing that the ionic diffusion resistance was significantly alleviated for the HAC-1 electrode. The mesopore ratio of HAC-1 significantly facilitates ion diffusion under low charge and discharge speed. Accordingly, the highly mesoporous structure of the HAC-1 electrode facilitates the ions diffusion and results in a high-performance EDL capacitor due to its ultrahigh surface area, which leads to high capacitance under low current density. The more hydrophilic surface of the HAC-2 sample improves the affinity of the electrode towards aqueous electrolyte, thus leading to the lower internal resistance.

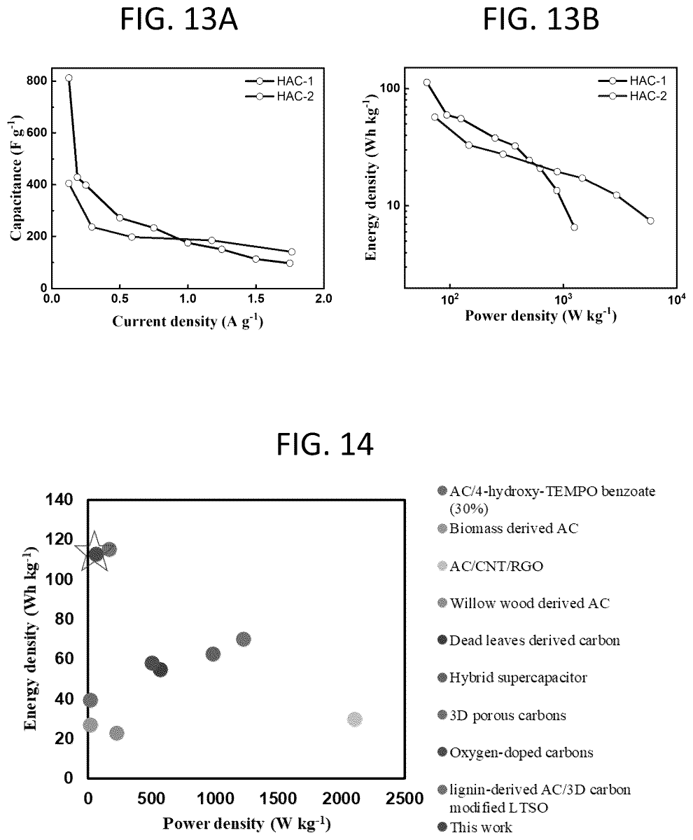

As shown in FIG. 13A, the capacitance of HAC-1 electrode reached 812.3 F g⁻¹ at 0.1 A g⁻¹, more than doubled that of the HAC-2 electrode (i.e., 405.2 F g⁻¹). Yet both of these results reflect the excellent electrochemical performance of the HACs. As the internal resistance starts to play a more important role of affecting the capacitance under high current density, the capacitance of HAC-1 decreases faster with the increased current densities, while HAC-2 achieves the plateau. The energy density and power density were calculated based on the following equations:

$$E = \frac{C {( Δ V )}^{2}}{2}$$

$$P = \frac{E}{Δ t}$$

where C is the specific capacitance (F g⁻¹), ΔV (V) is the potential window, and Δt(s) is the discharge time. The calculated results are shown in the Ragone plots shown in FIG. 13B. The HAC-1 based SCs achieved an ultrahigh energy density of 112.8 Wh kg⁻¹ at a power density of 62.5 W kg⁻¹, while HAC-2 based SCs obtained better power density performance with the power density of 5882.4 W kg⁻¹ at the energy density of 7.5 Wh kg⁻¹. As shown in FIG. 14, compared to the energy density and power density of SCs with various electrodes from other publications, HAC-1 based SCs achieved superior performance with ultra-high energy density.

### MB Adsorption Performance

To investigate the potential utilization of activated carbons in dye removal, the cation dye methylene blue (MB) (below) was involved in the dye adsorption study.

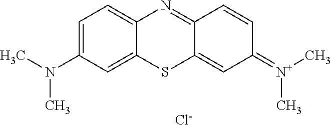

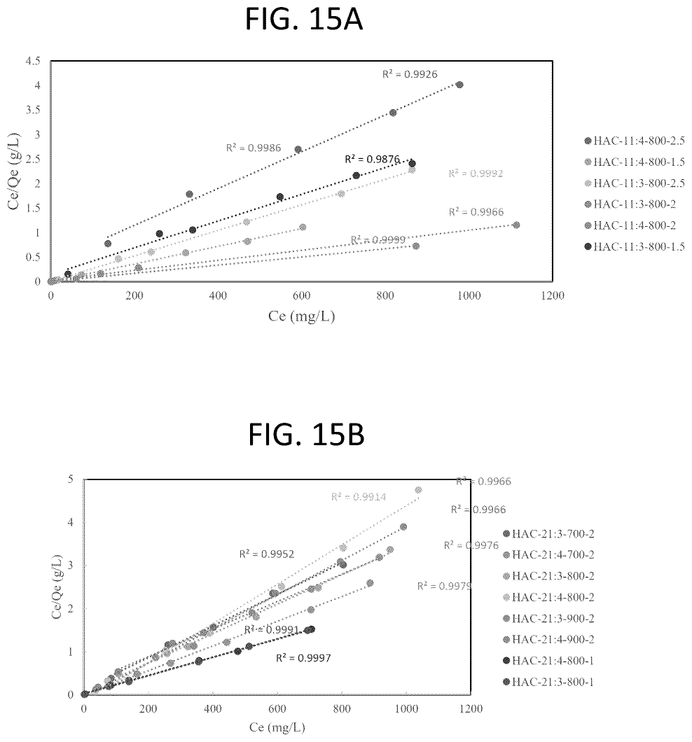

The adsorption isotherm is used to study the relationship between adsorbate molecules and adsorbent surface. As shown in FIG. 15A, the linear Langmuir model was fitted with the equilibrium data using the following equation, and the fitting results were all presented with high statistical indicators R² (Table 5).

$$\frac{{C}_{e}}{{Q}_{e}} = \frac{1}{{Q}_{m} {K}_{L}} + \frac{{C}_{e}}{{Q}_{m}}$$

where K_{L} is Langmuir isotherm constant (L/mg), Cₑ, Qₑ, and Qₘ are the MB concentration at equilibrium (mg/L), adsorption capacity at equilibrium (mg/L), and maximum adsorption capacity (mg/g), respectively. Therefore, the high R² values (>0.99) indicated that Langmuir model was suitable to describe MB adsorption on activated carbons and the adsorption process could be considered as a monolayer adsorption type with finite adsorption sites and uniform adsorption energies. The theoretical Qₘ can be calculated from the above equation and the results are listed in Table 5. Based on the results of sample surface area and maximum adsorption capacity, both the HAC-1 and HAC-2 results showed that higher surface area resulted in higher maximum adsorption capacity, indicating that the higher surface area provided more available sites for attracting MB dye molecules to the activated carbon surface through electrostatic attraction. The theoretical Qₘ of HAC-1 (1:4 mass ratio, 800° C., 2 hours) reached 1250 mg g⁻¹ implying the excellent dye removal ability. Although HAC-2 samples had relatively lower surface area compared to HAC-1 samples, the dye adsorption capacities were still impressive due to the abundance of functional groups and higher ratio of carboxyl/carbonyl groups on the HAC-2 surface. The maximum MB adsorption capacity that HAC-2 samples achieved was 476.19 mg g⁻¹.

TABLE 5
Sample surface area, maximum adsorption capacity,
and Langmuir adsorption statistical indicators.

| | Surface area | Qₘ | |
|---|---|---|---|
| Samples | (m² g⁻¹) | (mg g⁻¹) | R² |
| HAC-1_{1:3-800-1.5} | 1260 | 370.37 | 0.9876 |
| HAC-1_{1:3-800-2.5} | 1272 | 384.62 | 0.9992 |
| HAC-1_{1:4-300-2.5} | 1419 | 263.16 | 0.9926 |
| HAC-1_{1:4-800-1.5} | 1493 | 555.56 | 0.9959 |
| HAC-1_{1:3-800-2} | 2256 | 1000 | 0.9966 |
| HAC-1_{1:4-800-2} | 3207 | 1250 | 0.999 |
| HAC-2_{1:4-800-2} | 716 | 217.39 | 0.9914 |
| HAC-2_{1:3-900-2} | 786 | 250 | 0.9966 |
| HAC-2_{1:3-700-2} | 797 | 270.27 | 0.9952 |
| HAC-2_{1:3-800-2} | 1036 | 294.12 | 0.9966 |
| HAC-2_{1:4-900-2} | 1000 | 312.5 | 0.9976 |
| HAC-2_{1:4-700-2} | 1035 | 344.83 | 0.9979 |
| HAC-2_{1:3-800-1} | 1195 | 476.19 | 0.9997 |
| HAC-2_{1:4-800-1} | 1227 | 476.19 | 0.9991 |

### Conclusions Regarding Lignin-Derived Activated Carbons

The foregoing Examples investigated the effect of one-and two-step KOH activation on the surface properties of lignin-based activated carbons. One-step activation produced ACs having ultrahigh surface area as well as high mesopore ratio, leading to the ultrahigh energy density of the fabricated SCs as well as the ultrahigh MB adsorption capacity. The ionic diffusion resistance was greatly alleviated within the porous structure due to its high mesopore ratio. However, the relative hydrophobic surface limited its application for high power density SCs. In comparison, two-step activation produced ACs having limited surface areas but high oxygen contents. The oxygen not only existed on the surface but also doped inside the porous structure, leading to the hydrophilic surface. The hydrophilicity of these ACs greatly decreases the internal resistance and benefits the capacitance even at high current density, thus achieving the high power density of fabricated SCs. The dye adsorption capacities are also impressive due to the abundance of functional groups and higher ratio of carboxyl/carbonyl groups on the carbon surface. In summary, tailored pore structures of ACs with surface area from 50 to 3500 m² g⁻¹ and mesopore ratio from 10 to 80% can be produced through controlling process conditions according to our methodology. These lignin-derived ACs have promising potential to be applied for high performance supercapacitors as well as in environmental applications.

### Synthesis of Carbon Dots, for Example Carbon Quantum Dots From Lignin

KSW lignin was pyrolyzed in a crucible in a tube furnace at 1000° C. for 30 mins. The heating rate was set as 10° C./min and the nitrogen gas flow rate was 3 L/min. After the pyrolyzed lignin was collected, physical activation was first carried out in furnace with humidity control under 800° C. for 0.5 hour. After that, the samples were exposed to CO₂ flow at 800° C. for 0.5 hour. The produced ACs were placed in high concentration nitric acid (8 M HNO₃) and stirred at hot plate for 4-6 hrs. Produced samples were washed by DI water to obtain the neutralized carbons, which are referred to as H-ACs.

H-ACs in the amount of 0.1 g were mixed with 1 ml H₂O₂ and 2 ml DMF solvents. After fully stirring, the mixtures were transferred into the stainless-steel Teflon-lined autoclave. The heating process was carried at 110° C. for 1.5, 2, 3, 4, 8, and 16 hours, producing CQD samples labeled as H-AC-xh, where x is the time, e.g., H-AC-1.5h to H-AC-16h.

### Separation and Purification of CQDs

The produced CQDs were first separated via ultra-centrifugation at 20k g for 0.5 hr. To further purify the obtained CQDs, flash chromatography was conducted using the mixture of ethanol and milli Q water as eluent with varying volume ratio (from 10:1 to 1:10).

### Results and Discussion of CQD Experiments

This section describes the optical properties of the CQDs produced from the foregoing process. One goal is to develop a predictive processing-structure-property-performance (PSPP) relationship for lignin-based carbon dots, for example carbon quantum dots. This section ties the observed optical properties to the processing conditions. A thorough characterization of the structure of the CQD remains to be determined. The structural characterization is important to decouple the distinct impacts of surface functionality and size on the optical properties.

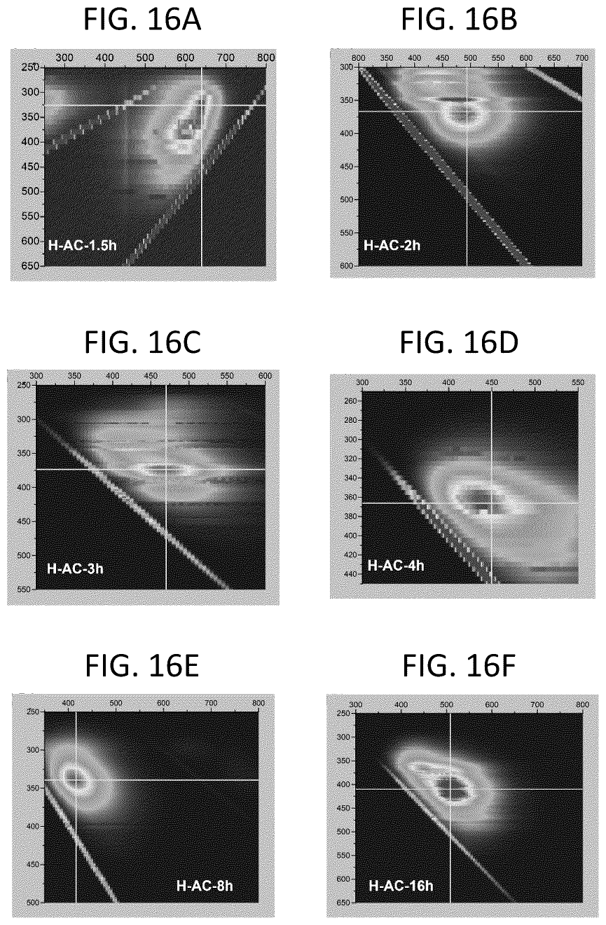

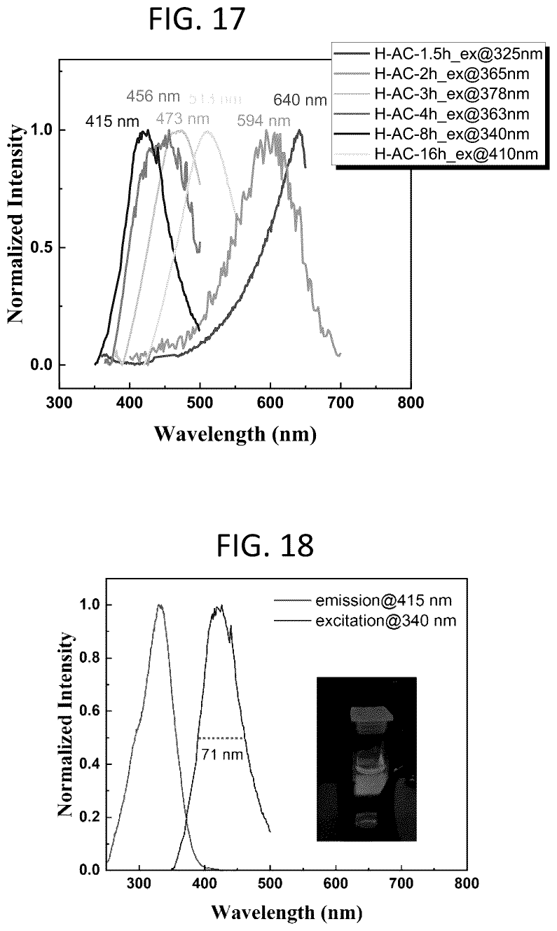

FIGS. 16A-16F show the fluorescence mapping spectra of the produced CQDs. For processing times from 1.5 hours to 8 hours, there was a monotonic relationship between processing time and the peak emission wavelength. The short processing times correspond to longer wavelengths, (640 nm (red light) at 1.5 hours, which gradually changes to shorter wavelengths (415 nm, blue light) at 8 hours. The exception to this rule is the 16-hour processing time, which yielded an intermediate yellow light at 513 nm. The photoluminescence (PL) emission spectra of samples are shown in FIG. 17. The emission peaks are located at 415 nm (H-AC-8h), 456 nm (H-AC-4h), 473 nm (H-AC-3h), 513 nm (H-AC-16h), 594 nm (H-AC-2h) and 640 nm (H-AC-1.5h), respectively.

Ignoring the 16-hour exception, the reaction duration played an important role in determining the optical property of synthesized CQDs. Longer processing times lead to a redshift of the emission spectra. As the larger CQDs are associated with longer wavelengths, the results suggest that the CQDs emitting red light are larger than CQDs emitting blue light. In conclusion, longer processing times up to 8 hours result in smaller CQDs. This is a sensible observation because the process of activation is one in which the activating agent decomposes the starting material. The contrary behavior at 16 hours processing time has yet to be explained.

As shown in FIG. 16E, the H-AC-8h CQDs displayed a narrow distribution of emission and excitation spectra, and the single round shape in excitation-emission mapping spectra confirms the high purity of this sample. The corresponding PL spectra is shown in FIG. 18. The emission peak of H-AC-8h centered at ˜415 nm with a narrow FWHM˜71 nm, much smaller than the FWHM of conventional blue CQDs. The deep blue emission achieved the lowest wavelength compared with the current publications of CQDs and it is even lower than that of conventional inorganic (perovskite and Cd²⁺/Pb²⁺-) quantum dots. The H-AC-8h sample achieved excellent fluorescence performance, not only the deeper blue color, but also the narrow emission peak.

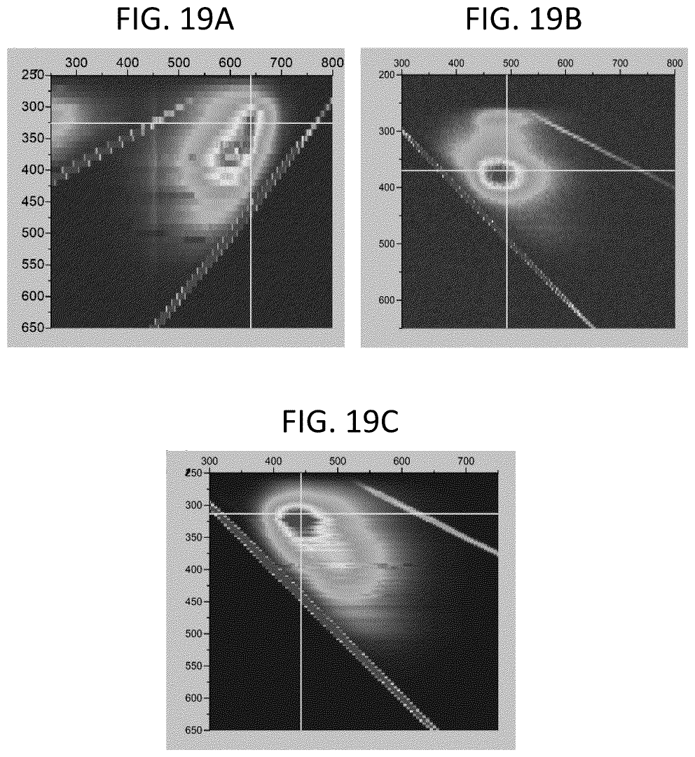

There was also a change in the fluorescence spectra as a function of the concentration of the materials in solution. For example, the fluorescence spectra of H-AC-1.5h were shifted as the concentration of samples changed (shown in FIGS. 19A-19C). At low concentration, a single emission peak was observed at about 440 nm (excitation wavelength of ˜320 nm) as shown in FIG. 19A. At medium concentration, a single emission peak was observed at about 480 nm (excitation wavelength of 380 nm) as shown in FIG. 19B. At high concentration, a broader emission peak was observed at wavelengths from 600 to 640 nm (excitation wavelengths from 300 to 380 nm) as shown in FIG. 19C. This phenomenon may be due to the aggregation of CQDs. With increasing concentration, the attraction between CQD molecules and the interaction between CQD and water molecules promote the aggregation of CQDs and leads to the increasing size of CD agglomerates, thus resulting in the red shift of fluorescence spectra.

While the foregoing Examples establish a clear processing-property relationship and allow the inferring of some structural information, an unambiguous structural characterization still needs to be performed.

### Conclusions Regarding Carbon Dots, for Example Carbon Quantum Dots

The foregoing Examples propose a synthesis method that effectively produced lignin based CQDs with multi-color emissions from red to deep blue. Of special note, deep blue color CQDs were discovered that achieved emission peak centered at 415 nm and FWHM of 71 nm. The deep blue emission was comparable with that of conventional inorganic (perovskite and Cd²⁺/Pb²⁺-) quantum dots, thus expanding the applications of CQDs for the optoelectronic devices. A fluorescence spectra redshift was discovered, caused by the aggregation of CQD molecules under increased concentrations. These Examples established the processing and optical property components of the processing-structure-property-performance (PSPP) relationship. Structural characterization remains to be completed to determine morphology and size, molecular weight, surface charge, and chemical composition.

The embodiments described herein are not limited in their application or use to the details of construction and arrangement of parts and steps illustrated in the drawings and description. Features of the illustrative embodiments and variants may be implemented or incorporated in other embodiments, variants, and modifications, and may be practiced or carried out in various ways. Unless otherwise indicated, the terms and expressions employed herein have been chosen for the purpose of describing the illustrative embodiments of the present invention for the convenience of the reader and are not for the purpose of limiting the invention. Having described the invention in detail and by reference to preferred embodiments thereof, it will be apparent that modifications and variations are possible without departing from the scope of the invention which is defined in the appended claims.

What is claimed is:

1. A method of preparing microporous activated carbon having a controlled surface area, comprising the steps of:
providing a lignin including one or more of softwood lignin, hardwood lignin, and herbaceous lignin;
carbonizing the lignin at an elevated temperature of at least about 700° C. to produce a carbonized lignin; and
activating the carbonized lignin by mixing it with potassium hydroxide at a mass ratio of about 1:3 to about 1:5 and an elevated temperature of at least about 700° C. to yield the microporous activated carbon;
wherein the microporous activated carbon has a controlled surface area of about 50 to about 3500 m²/g and a controlled mesopore ratio of about 10% to about 80%.

2. The method of claim 1, wherein the lignin comprises the softwood lignin.

3. The method of claim 2, wherein the softwood lignin is kraft softwood lignin.

4. The method of claim 1, wherein the microporous activated carbon has a surface area of at least about 3000 m²/g.

5. The method of claim 4, wherein the microporous activated carbon has a mesopore ratio of at least about 70%.

6. The method of claim 1, wherein the carbonizing and activating steps occur simultaneously.

7. The method of claim 6, wherein the simultaneous carbonizing and activating steps comprise mixing the lignin with the potassium hydroxide at a mass ratio of about 1:3 to about 1:5 and heating the mixture in an inert environment at a temperature of about 700° C. to about 900° C. for about 1 hour to about 3 hours.

8. The method of claim 1, wherein the carbonizing step occurs before the activating step.

9. The method of claim 8, wherein the carbonizing step comprises heating the lignin to a temperature of about 900° C. to about 1100° C. for at least about 0.5 hour to provide the carbonized lignin and pulverizing the carbonized lignin.

10. The method of claim 8, wherein the activating step comprises mixing the lignin with the potassium hydroxide at a mass ratio of about 1:3 to about 1:5 and heating the mixture in an inert environment at a temperature of about 700° C. to about 900° C. for about 1 hour to about 3 hours.

11. The method of claim 8, wherein the microporous activated carbon has a surface area of at least about 1200 m²/g and a mesopore ratio of at least about 25%.

12. A method of preparing carbon dots, comprising the steps of:
providing a lignin;
carbonizing the lignin at an elevated temperature of at least about 700° C. in an inert environment for at least about 0.5 hour to produce a carbonized lignin;
physically activating the carbonized lignin at a temperature of about 700° C. to about 800° C. in the presence of steam for at least about 0.5 hour, followed by exposing the activated carbon to carbon dioxide to a temperature of at least about 700° C. for at least about 0.5 hour, to yield activated carbon;
treating the activated carbon with concentrated nitric acid;
washing the activated carbon to obtain neutralized activated carbon;
mixing the neutralized activated carbon with hydrogen peroxide and solvent to yield a mixture;
heating the mixture to at least about 110° C. for at least about 1.5 hours to yield the carbon dots; and
separating the carbon dots from the mixture.

13. The method of claim 12, wherein the carbon dots comprise carbon quantum dots.

14. The method of claim 12, wherein the lignin is selected from one or more of softwood lignin, hardwood lignin, and herbaceous lignin.

15. The method of claim 14, wherein the lignin comprises kraft softwood lignin.

16. The method of claim 12, wherein the carbonizing step comprises pyrolyzing the lignin in a furnace in an inert atmosphere and the temperature is raised to the elevated temperature using a heating rate of about 10° C. per minute.

17. The method of claim 12, wherein the separating step comprises centrifuging the mixture to separate the carbon dots.

18. The method of claim 12, further comprising the step of purifying the carbon dots using flash chromatography.

19. A method of preparing microporous activated carbon having a high surface area, comprising the steps of:
providing a softwood lignin;
mixing the softwood lignin with potassium hydroxide at a mass ratio of about 1:3 to about 1:5 and an elevated temperature of about 700° C. to about 900° C. for about 1 hour to about 3 hours to activate the lignin;
simultaneously carbonizing the lignin at the elevated temperature yield the microporous activated carbon;
wherein the microporous activated carbon has a surface area of at least about 2500 m²/g and a mesopore ratio of at least about 70%.

20. The method of claim 19, wherein the elevated temperature is maintained for about 1.5 hour to about 2.5 hour.

21. The method of claim 19, wherein the elevated temperature is at least about 800° C.

22. The method of claim 19, wherein the mass ratio of lignin to potassium hydroxide is about 1:4.

23. The method of claim 19, wherein the microporous activated carbon has a surface area of at least about 3000 m²/g and a mesopore ratio of at least about 75%.
